(19) United States
(12) Patent Application Publication
(10) Pub. No.: US 2007/0039502 A1
(43) Pub. Date: Feb. 22, 2007

(54) Imaged printing member, method and system for manufacturing it

(76) Inventors: Avigdor Bieber, Ra'anana (IL); Michael Karp, Petah Tikva (IL); Zeev Savion, Kibbutz Hanita (IL); Aida Porat, Kibbutz Hanita (IL); Ehud Shchori, Rehovot (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/585,984

(22) Filed: Oct. 25, 2006

Related U.S. Application Data
(63) Continuation-in-part of application No. 10/560,746, filed on Dec. 15, 2005.
(60) Provisional application No. 60/479,157, filed on Jun. 18, 2003.

(51) Int. Cl. B41N 3/00

(52) U.S. Cl. 101/467

(57) ABSTRACT

According to embodiments of the present invention, a method for manufacturing an imaged printing member is provided. The method may include imaging a selected image onto a transfer media which is coated with a surface forming coating by applying an image carry material onto the transfer media. Then, applying a coating material onto the substrate and/or the imaged transfer media and laminating the imaged transfer media with the substrate such that the coating material is captured in between. Next, the method may include conditioning the coating material to form the imaging layer of the printing member, the imaging layer having imaged areas and non-imaged areas, wherein the top layer of the non-imaged areas is an interface area between the coating material and the surface forming material.

### CROSS REFERENCE TO RELATED APPLICATIONS

This patent application is a continuation-in-part of U.S. patent application Ser. No. 10/560,746 filed on Dec. 15, 2005, which is a National Phase Application of PCT International Application No. PCT/IL2004/000519, International Filing Date Jun. 16, 2004, claiming priority of U.S. Provisional Application No. 60/479,157, filed on Jun. 18, 2003, all are hereby incorporated by reference.

### BACKGROUND

Traditional techniques of introducing a printed image onto a recording media involve offset lithography, gravure printing and relief printing. All these printing methods require a printing plate to transfer ink in the pattern of the image to the recording media.

In the case of offset lithography, the image is present on the member as a pattern of ink-accepting and ink-repellent surface areas. For offset lithography using a dry printing system, the printing member is inked and the image transferred onto a recording media. In a wet lithographic system, the non-image areas are hydrophilic and the ink-repellency is provided by dampening the printing member prior to printing.

The process of producing an imaged lithographic printing member usually involves manufacturing a blank member, shipping the blank printing member to the printers and imaging the printing member prior to printing. There is a need for a printing member that can be manufactured on demand at the print shop.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIGS. 1-3 are pictorial illustrations of exemplary systems for producing imaged printing members according to embodiments of the present invention;

FIGS. 4-5 are pictorial illustrations of exemplary plate-making systems having an imaging unit according to embodiments of the present invention;

FIG. 6 is a flowchart illustration of a method for producing imaged printing members according to embodiments of the present invention;

FIGS. 7A-7C are pictorial illustrations showing the manufacturing process of an exemplary imaged printing member according to embodiments of the present invention;

FIG. 8 is a pictorial illustration of an exemplary plate-making system having an imaging unit and an image-carrying belt according to embodiments of the present invention;

FIG. 9 is a flowchart illustration of a method for producing imaged printing members according to embodiments of the present invention; and

FIGS. 10A-10D are pictorial illustrations showing the manufacturing process of an exemplary imaged printing member according to embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the embodiments of present invention may be practiced without these specific details. In other instances, well-known methods, procedures and components have not been described in detail so as not to obscure the present invention.

Embodiments of the present invention are directed to a method of producing an imaged printing member. According to some embodiments of the present invention, the imaged printing member may be a lithographic printing member suitable for dry or wet printing systems. According to other embodiments, the imaged printing member may be relief or gravure printing members. It should be noted that the terms “printing member” and “printing plate” are used interchangeably throughout the specification and claims.

According to embodiments of the present invention, the method may include imaging a transfer media by applying an image carry material on selected areas of the transfer media according to a predefined pattern. The image carry material may be toner or ink or other suitable materials such as acrylates or polyester resins. The image carry material may be transparent or alternatively it may include a colorant such as dye or pigment.

The method may include applying a coating material on a substrate or the imaged transfer media and laminating the imaged transfer media with the substrate such that the coating material is captured between the substrate and the transfer media and the image carry material is trapped between the imaged transfer media and the coating material. Then, the method may include curing the coating material to form the imaged printing member. The method may include removing the transfer media while keeping the image carry material on the printing member.

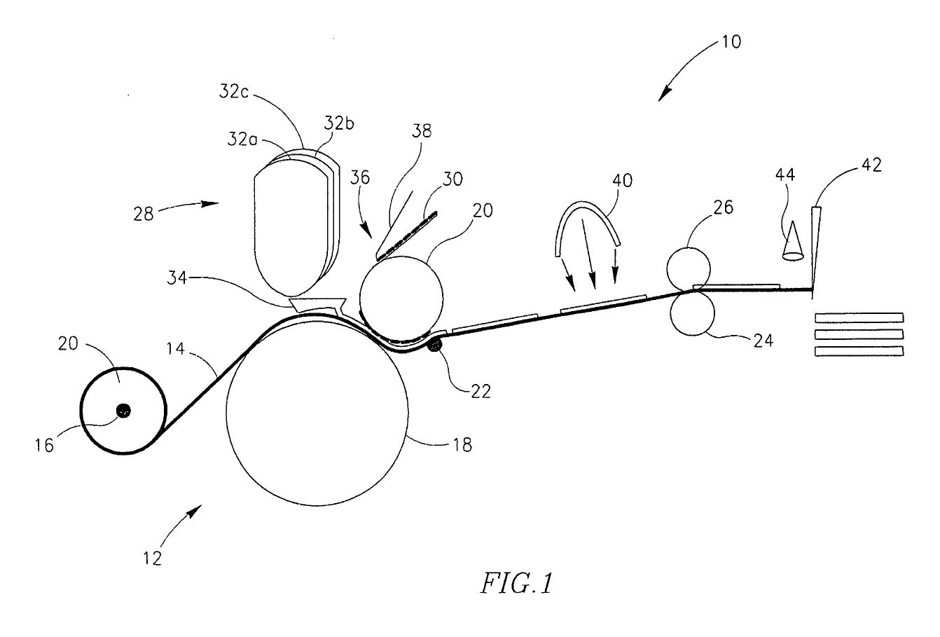

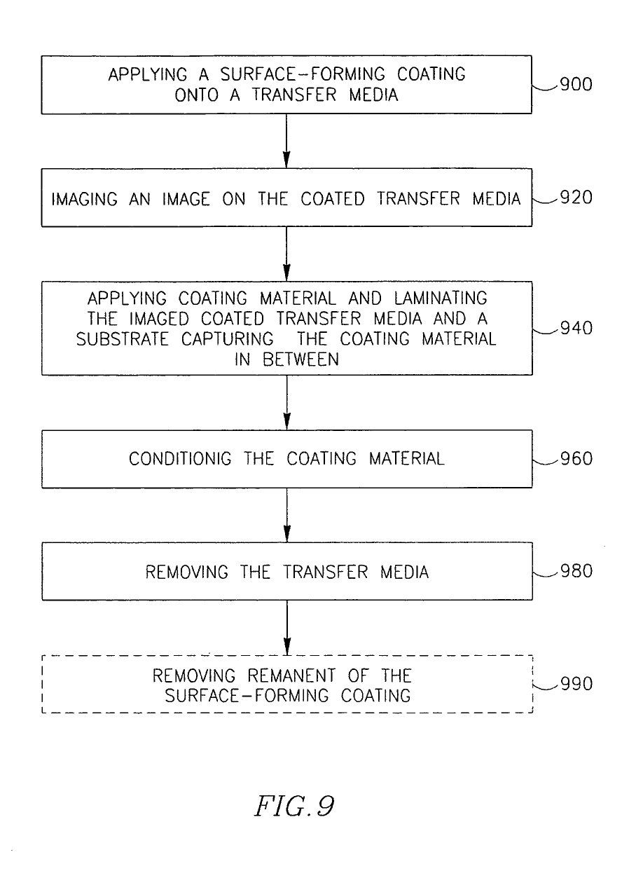

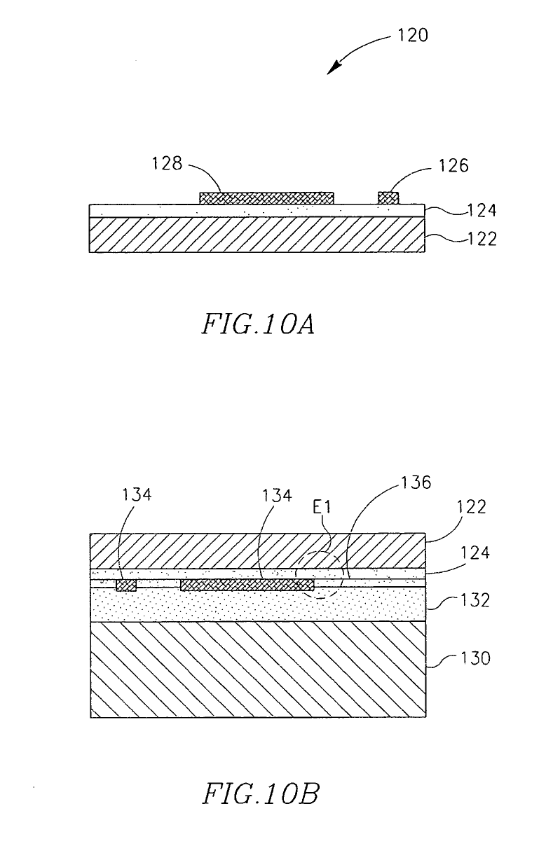

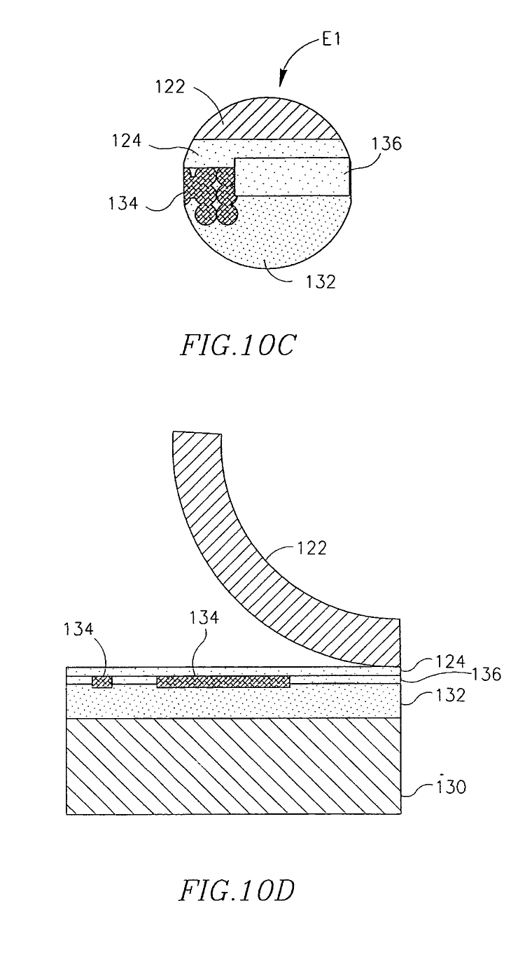

According to some embodiments of the present invention the method may include applying a hydrophilic layer to the transfer media prior to imaging as described in detail with reference to FIGS. 9 and 10A-10D The methods of producing the imaged printing members according to embodiments of the present invention may be implemented, for example, by using the plate-making systems described below with reference to FIGS. 1-5.

FIGS. 1, 2 and 3 schematically illustrate a system for producing imaged printing members according to exemplary embodiments of the present invention. System 10 may include a substrate handling module 12 to support and conduct at controlled speed a substrate 14. Substrate handling module 12 may include, for example cylinders 16 and 18 to carry substrate 14 being in a form of a roll 20, a set of cylinders represented by cylinders 18, 20 and 22 to press and guide the laminated substrate in the appropriate path and driver rollers 24 and 26 actuated by a controlled motor (not shown) to pull the laminated substrate at the required speed.

It should be understood to a person skilled in the art that the configuration of the substrate handling module described above is only exemplary and that the scope of the invention is not limited to this specific configuration. According to other embodiments of the present intention, the substrate handling module may include, for example a sheet feeder unit to handle substrate 14 being in a form of sheets. Alternatively, other transporting mechanisms, as known in the art, may be used.

System 10 may include, for example a coating unit 28 to hold and apply a coating material onto substrate 14 and/or onto an imaged transfer media 30 before the lamination operation. Coating unit 28 may include, for example one or more cartridges 32, an applicator 34 to apply the formulation and a controller (not shown). Although three cartridges 32A, 32B, 32C are shown in the exemplary illustration of FIG. 1, it should be understood to a person skilled in the art that the scope of the invention is not limited in this respect and system 10 may comprise any suitable number of cartridges.

System 10 may include for example a lamination unit 36 to hold and conduct imaged transfer media 30. The transfer media may be a thin film, a release paper, a polyester film, a polyvinylchloride film and the like. Lamination unit 36 may include, for example a sheet feeder 38 to guide imaged transfer media 30 being in a form of sheets over cylinder 20 to enable the lamination of imaged transfer media 30 and substrate 14 when both are pressed between cylinders 20 and 18. Alternatively, lamination unit 36 may include a cylinder (not shown) to carry and guide imaged transfer media 30 being in a form of a roll. Several methods, as know in the art, may be used to hold imaged transfer media 30 on cylinder 20, for example, the usage of localized vacuum or controllable electrostatic forces, grippers, registration pins, a clamping system and any other method know in the art including manual handling.

Other exemplary embodiments of the present may include alternatively or additionally a sheet feeder that carries one or more sheets of substrate (not shown in the drawing). At the appropriate time, the substrate sheet feeder may release one sheet of substrate to a transfer mechanism that carries the substrate. The sheet transfer mechanism may be represented by roller 18. Any method known in the art may be used to hold the sheet onto the transfer mechanism, for example localized vacuum, controllable electrostatic force, grippers, registration pins, a clamping system, or any other suitable method including manual handling.

Yet another exemplary embodiment of the present invention may include a static substrate handling mechanism and a movable coating mechanism (not shown in the drawings). For the manufacturing process, the static substrate mechanism may be loaded with a sheet of substrate. The movable coating mechanism may include a movable coating unit, a lamination unit and a curing unit. The coating unit may apply a coating material onto the substrate and/or onto the imaged transfer media while the moving coating mechanism is moved over the sheet. The lamination unit may include, for example, sheet feeder 38 to guide imaged transfer media 30 being in a form of sheets onto cylinder 20 to enable the lamination of imaged transfer media 30 and the sheet of substrate when both are pressed between cylinders 20 and the static substrate handling mechanism.

System 10 may include for example a conditioning unit 40 to solidify the coating material. Conditioning unit 40 may include for example, an ultraviolet (UV) radiation unit, an infrared radiation unit and others. In the exemplary illustration of FIG. 1, conditioning unit 40 is located facing imaged transfer media 30. Alternatively, according to other embodiments of the present invention the conditioning unit may be located facing substrate 14. In these embodiments, when the conditioning unit is a UV radiation unit, substrate 14 is made of a material transparent to UV radiation. Alternatively, according to other embodiments, system 10 may comprise two conditioning units located from both sides of the laminated substrate.

System 10 may include for example a cutting unit 42 to cut the product into its final desired size. The cutting operation may be performed at all the edges of the laminated substrate (both X and Y axes). System 10 may further include an optical unit 44 to identify cutting marks on the printed media, as known in the art. As shown, in the exemplary embodiment of FIG. 1, cutting unit 42 is located such that the cutting operation is performed after the laminated substrate has been treated by conditioning unit 40 and the coating material has been cured.

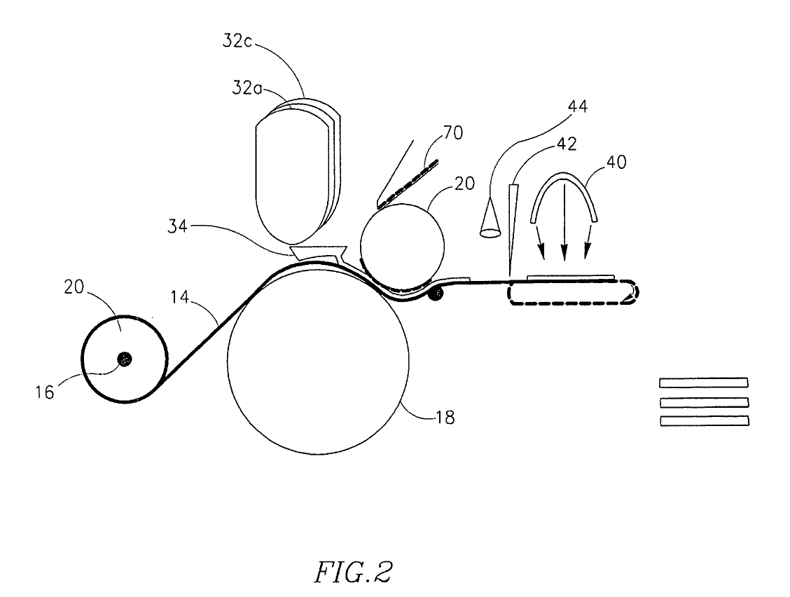

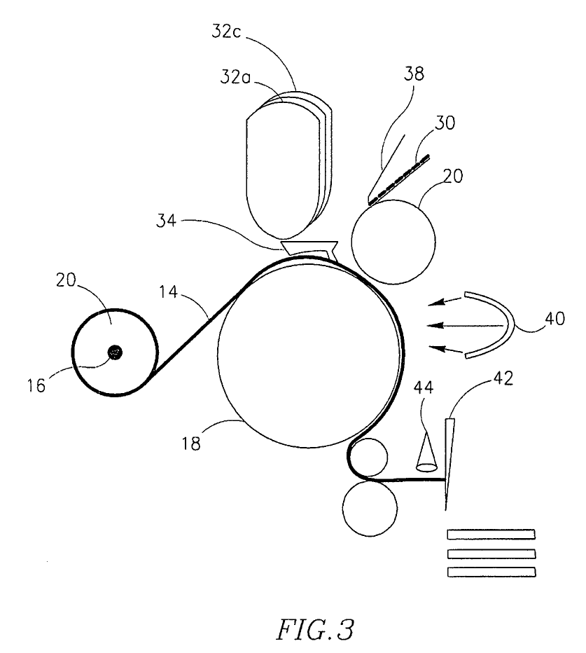

According to other exemplary embodiments of the present invention, as illustrated in FIG. 2, the position of cutting unit 42 together with optical unit 44 and conditioning unit 40 may be replaced. In these embodiments, substrate 14 may be sliced in areas not covered by the formulation. FIG. 3 schematically illustrates another exemplary system for producing imaged printing members according to embodiments of the present invention. In these embodiments, conditioning unit 40 is located facing cylinder 18, which serves as the lamination cylinder.

The plate-making system depicted in the exemplary embodiments may include for example, a registration system to drive the imaged transfer media 30 in registration with substrate 30 in any suitable method known in the art.

According to other embodiments of the invention, the plate-making system may include an imaging unit to selectively apply image carry material onto the transfer media inline prior to the lamination process. Non-exhaustive examples of such an imaging unit may include an electrophotographic printer, an inkjet printer, ionographic printer, laser printer and any other suitable imaging systems known in the art.

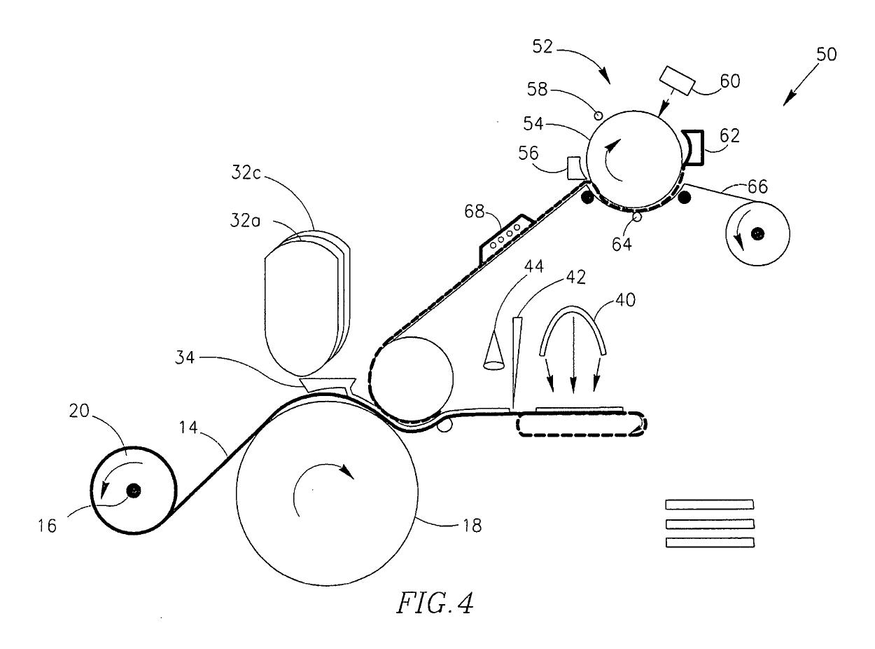

Reference is now made to FIG. 4, which schematically illustrates an exemplary plate-making system having an electrophotographic printing system as the imaging unit according to embodiments of the present invention. System 50 may include, for example a standard electrophotographic printing system 52 having an electophotographic drum 54, a cleaning station 56, a recharge station 58, a laser & scanning unit 60, a developing station 62 which contains an image carry material such as electrostatic toner and a transfer station 64 to transfer the image carry material to a transfer media 66 provided in a form of a roll. The operation of electrophotography is well known in the art and therefore will in be discussed in detail.

System 50 may include for example a fusion station 68 to fixate the image on transfer media 66. The Fixation should be at a level that would enable further operations according to embodiments of the invention as explained in details below. It should be understood that the specific exemplary configuration of system 50 does not limit the scope of the invention and other configurations such as the exemplary configuration illustrated in FIG. 5 are likewise applicable.

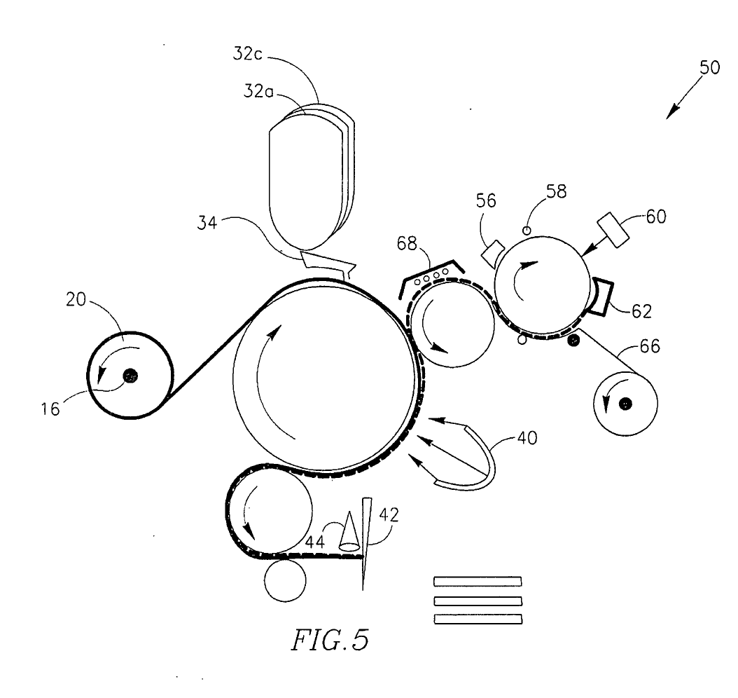

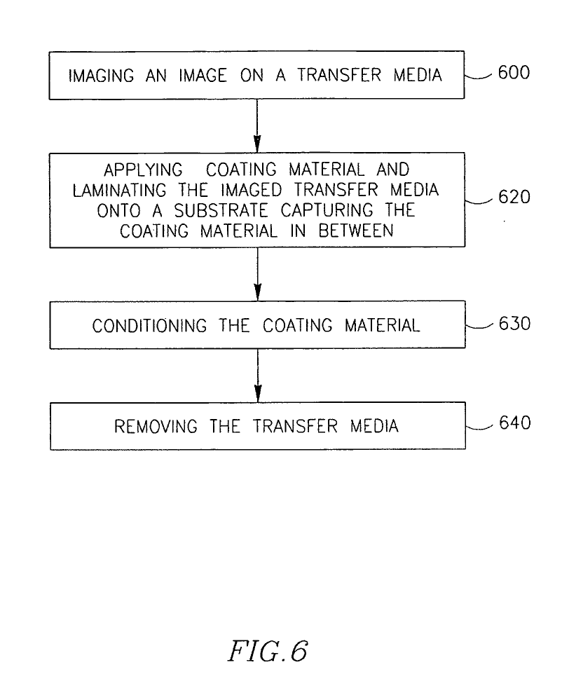

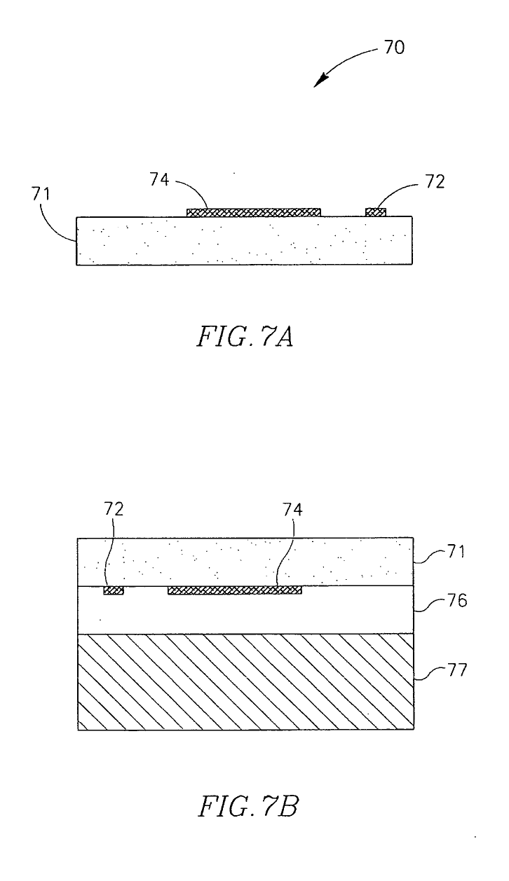

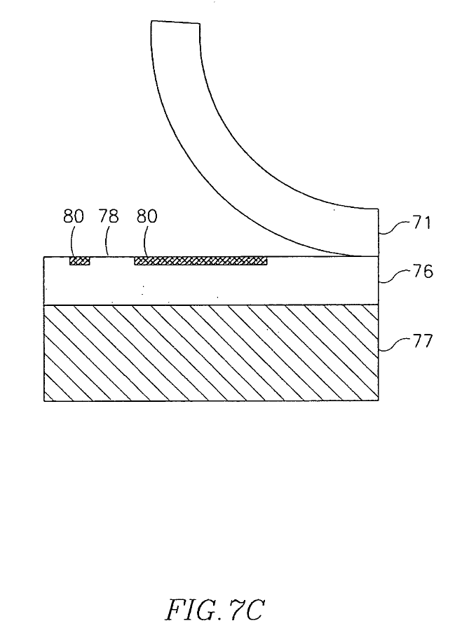

Reference is now made to FIG. 6, which is a flowchart diagram demonstrating a method for producing an imaged printing member according to embodiments of the present invention. Reference is additionally made to FIGS. 7A-7C, which are pictorial illustrations showing the production process.

As indicated at box 600, the method may include imaging an image on a transfer media by selectively applying an image carry material to the transfer media. FIG. 7A is a cross sectional illustration of an imaged transfer media 70. The imaged transfer media may include a blank transfer media 71 having on its surface two areas 72 and 74 on which the image carry material was selectively applied according to a pre-defined pattern.

The imaging operation may be performed inline on a plate-making system having an imaging unit or at a separate imaging system. The imaging operation may be preformed in various imaging technologies such as for example, laser printing, electophotography printing, inkjet printing, wax thermal transfer, iconography and others. Various image carry materials may be used, such as laser printer toner, inkjet ink and others.

A transfer media suitable to be used as an image transfer media according to embodiments of the present invention is provided. The transfer media may be continuously wound in a form of a roll. Alternatively, sheets of transfer film or release paper may be used in the manufacturing process.

As indicated at box 620, the method may include applying the coating material onto a substrate 77 and/or imaged transfer media 70. Imaged transfer media 70 is then laminated onto substrate 77 such that the coating material is trapped between substrate 77 and imaged transfer media 70. This lamination process may be done by any suitable lamination process known in the art, such as ironing lamination described in WO 04/014651, silkscreen, wire wound rod, offset coating, gravure and other methods.

The substrate material may be continuously wound in a form of a roll. The substrate may be a polymeric substrate such as, for example, a polyester (PET) film, a polypropylene (PP) film, polycarbonate (PC) film and PVC film. The film may be coated with silicone or any other suitable coating and may be laminated to a substrate to improve its mechanical properties. According to some embodiments of the present invention the film and the substrate if exists may be transparent to ultraviolet (UV) radiation. Alternatively, sheets of substrate material may be used in the manufacturing process such as for example aluminum sheets.

FIG. 7B illustrates the outcome of the lamination process. As illustrated, the coating material 76 is captured between imaged transfer media 70 and substrate 77. According to embodiments of the present invention, during the lamination process, the image carry material may be dipped, wholly or partially, into coating material.

The coating material may be a material having oleophobic properties. An exemplary formulation of the coating material may include polydimethyl siloxane substituted with functional groups which may be cross linked by UV radiation. Non-limiting examples of suitable functional groups may be epoxy, acrylate and vinyl. The formulation may comprise photoinitiators to allow cross-linking and/or polymerization by ultraviolet radiation. Other additives, such as, but not limited to adhesive promoters and modifiers to improve the mechanical and surface properties of the coating layer may be added to the formulation.

The coating material may be prepared on-demand for a single use. The coating material according to other exemplary embodiments of the present invention may comprise alternatively or additionally other functional groups, such as, but not limited to, vinyl and silane that may provide crosslinking via addition curing, condensation curing and moisture curing. According to other embodiments, the coating material may be oleophilic. Non-exhaustive examples of suitable oleophilic materials may be ultraviolet curable acrylates, such as for example, urethane acrylate oligomeres, epoxy acrylate oligomers, acrylate monomers and methacrylate monomers.

As indicated at box 630, the method may include conditioning the coating material to form a solid imaging layer. The conditioning may include radiation curing, such as ultraviolet curing, thermal curing and fusing using one or more conditioning units. As indicated at box 640 and illustrated in FIG. 7C, the method may include removing transfer media 71 to expose the desired image on the surface of the imaging layer.

It should be understood, that the image on the imaging layer is the mirror-image of the pattern formed by the image carry material on the transfer media. As illustrated in FIG. 7C, the imaged surface of the imaging layer produced by the process described above includes blank areas 78 made of the coating material and imaged areas 80 made of the image carry material. It should be understood to a person skilled in the art of printing, that the blank areas and the imaged areas have different affinity to ink and/or ink-repellent fluid.

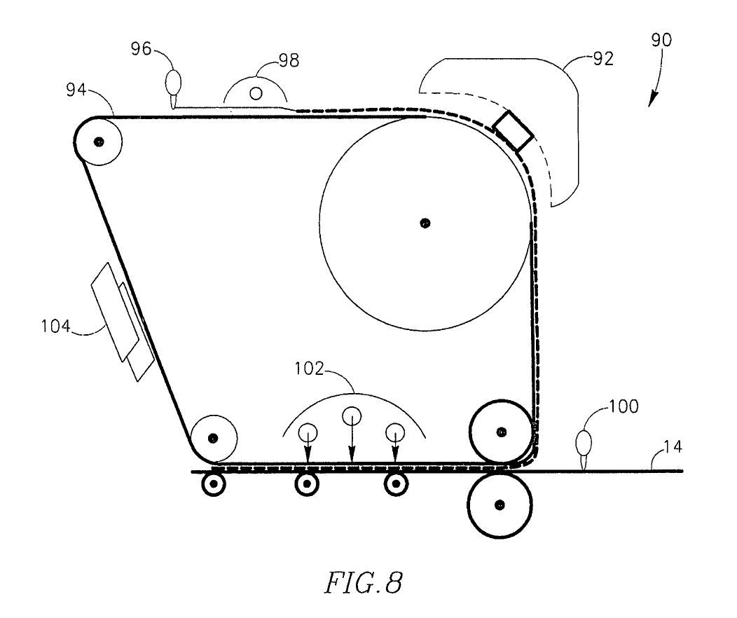

Reference is now made to FIG. 8, which schematically illustrates an exemplary plate-making system 90 having an imaging unit 92 according to embodiments of the present invention. System 90 may include an image carrier belt 94 and a belt coating unit 96. Belt coating unit 96 may be used to coat image carrier belt prior to the imaging stage. Optionally, system 90 may include a drying unit 98 near the belt coating unit to dry the coating layer applied to the belt.

System 90 may further include an applicator 100 to apply a coating material onto substrate 14 prior to the lamination process and a conditioning unit 102 to harden the coating material into a solid imaging layer. System 90 may further include a cleaning unit 104 to clean image carrier belt 94 and prepare it for a new cycle.

Reference is now made to FIG. 9, which is a flowchart diagram demonstrating a method for producing an imaged printing member according to embodiments of the present invention. Reference is additionally made to FIGS. 10A-10D, which are pictorial illustrations showing the production process.

As indicated at box 900, the method may include applying a surface forming coating onto the surface of a transfer media, such as image transfer belt 94. It should be understood, however, that the embodiments directed to the application of the surface forming coating on a transfer media are not limited to an image transfer belt, rather, the transfer media may be a transfer film in a form of sheets or rolls.

The coated transfer media may be used for the manufacture of printing members for wet offset printing. According to embodiments of the present invention, in the manufacturing process, the surface forming coating may form hydrophilic surface on non-imaged areas of the printing member, namely, areas which would be dampened in the printing process. It should be noted that a coating that forms the hydrophilic surface according to embodiments of the present invention may be termed “active hydrophilic coating”.

The active hydrophilic coating may include a water-based composition soluble in water having hydrophilic molecules and/or polymers. The composition may include one or more compatible polymers, which may include acrylic, epoxy and vinyl functional groups. Exemplary suitable hydrophilic polymers may include poly(vinyl alcohol) (PVA), poly (vinyl pyrrolidone) (PVP), poly-oxazoline, poly(acrylamide), poly(acrylic acid) (PAA), poly(methacrylic acid), copolymers of maleic anhydride and maleic acid, and poly(vinyl phosphonic acid) and their copolymers. Other useful polymers may include some of the water soluble polysaccharides such as cellulose ethers, including hydroxyethyl-cellulose and hydroxypropyl-cellulose and their derivatives. Other exemplary hydrophilic polymers may include amino glucoside, chitosan and carboxymethyl derivatives of polysaccharides and other carboxylated polymers such as alginates, pectin and other natural polysaccharides.

Although, embodiments of the present invention are not limited in this respect, it is believed that specific functional groups within the materials listed above or their derivatives may react, under certain conditions such as UV curing, with functional groups of compositions within the coating material such that in the interfacing areas, the surface properties of the coating material changes. According to embodiments of the present invention, these reactions may form hydrophilic surface areas on the hydrophobic bulk material.

Some materials may react with the coating material without any modification. For example, poly(vinyl pyrrolidone) may be combined with the carboxylic groups in the coating material to form hydrophilic interface areas on selected areas on the surface of the coating material. Another example may be the reaction of polymers containing a carboxy group with basic segments, such as amino groups, cyclic amide groups and quaternary ammonium groups within the coating material to form hydrophilic surface areas on the hydrophobic bulk material.

Some hydrophilic polymers may be modified to include polymerizable groups such as acrylic, acrylamido and methacrylic groups. Such substitutions may be achieved by reacting hydroxyl-containing polymers, such as, poly (vinyl alcohol) and cellulosic polymers with reactants such as N-methylolacrylamide (NMA) or isocyanato-ethyl-methacrylate (IEM). Another example of such a substitution is the reaction of glycidyl-methacrylate (GMA) with carboxy-containing polymers such as PAA and copolymers of maleic anhydride. Yet another example of such a substitution is the reaction of GMA or IEM with amine-containing polymers, such as chitosan.

The polymers may be derivatized to contain polymerizable groups by a one-step reaction as shown above or alternatively by a multi-stage reaction. An example of a multi stage reaction to include a polymerizable group, is the derivatization of PVA to form acetal with glyoxalic acid, followed by a reaction of the carboxylic acid group with GMA to achieve a methacrylate substitution.

Following are exemplary processes for the preparation of the coated transfer media. In the following examples, component designations are in weight percentages.

### EXAMPLE 1

(a) preparing the active hydrophilic coating

TABLE 1

| Weight % | Ingredients of active hydrophilic coating |
|---|---|
| Part I | |
| 18.7 | Acetone |
| 3.74 | copolymer of methylvinyl ether and maleic anhydride, sold |
| | under the trade name of Gantrez AN119 by ISP, Wayne, |
| | New Jersey |
| 0.69 | Hydroxyethyl acrylate (HEA) |
| 0.04 | Triethyl amine |
| Part II | |
| 3.5 | Water |
| Part III | |
| 31.4 | 10% water solution of polyvinyl alcohol sold under the |
| | trade name of Cevol 523 by Celanese, Dallas, USA |
| 0.73 | Wetting agent, sold under the trade name of Q2 5211 by |
| | Dow Corning Midland, USA |
| 0.51 | Amorphous silicone dioxide agent, sold under the trade |
| | name of Syloid C809 by Grace Davidson Worms, Germany |
| b.t.w | Water |

The components of Part I of the Table 1 presented above are mixed and left to react for a reaction period of about 24 hours. Although, embodiments of the present invention are not limited in this respect, it is believed that the hydroxyethyl acrylate is bound to the copolymer by the reacting its hydroxyl group with the anhydride group of the hydrophilic copolymer. At the end of the reaction period 3.5% water (as indicated in Part II of Table 1) are added to the solution. Although, embodiments of the present invention are not limited in this respect, it is believed that the water hydrolyze the residual anhydride groups of the copolymer and form a highly polar acid. Upon completion of the hydrolysis reaction, the components of Part III are added to the solution.

(b) The active hydrophilic coating is coated onto a SH-81 clear 125 micron PET film sold by SKC, Covington, USA using a rod #3 sold by RK Print Coat Instrument Litington, UK. The coated film is then dried at 70° C.

### EXAMPLE 2

(a) preparing the active hydrophilic coating

TABLE 2

| Weight % | Ingredients of active hydrophilic coating |
|---|---|
| Part I | |
| 25.2 | 35% Polyacrylic acid solution in water, sold under |
| | the trade name Sokalan PA 110S by BASF, |
| | Ludwigshafen, Germany |
| 14.1 | Acetone |
| 1.7 | Glycedyl methacrylate (GMA) |
| 0.3 | Triethyl amine, |
| Part II | |
| 15 | 10% water solution of polyvinyl alcohol sold under |
| | the trade name of Cevol 523 by Celanese, |
| | Dallas, USA |
| 0.7 | Wetting agent, sold under the trade name of Q2 |
| | 5211 by Dow Corning Midland, USA |
| 2 | Amorphous silicone dioxide agent, sold under the |
| | trade name of Syloid C809 by Grace Davidson |
| | Worms, Germany |
| 20 | Isopropanol |
| b.t.w | Water |

The components of Part I of the Table 2 presented above are mixed and left to react for a reaction period of about 72 hours. At the end of the reaction period, the components of Part II are added to the solution.

(b) The active hydrophilic coating is coated onto a SH-81 clear 125 micron PET film sold by SKC, Covington, USA using a rod #3 sold by RK Print Coat Instrument, Litington, UK. The coated film is then dried at 70° C.

### EXAMPLE 3

(a) preparing the active hydrophilic coating

TABLE 3

| Weight % | Ingredients of active hydrophilic coating |
|---|---|
| Part I | |
| 16.5 | 35% Polyacrylic acid solution in water, sold under |
| | the trade name Sokalan PA 110S by BASF, |
| | Ludwigshafen, Germany |
| 9.2 | Acetone |
| 1.1 | Glycedyl methacrylate (GMA) |
| 0.2 | Triethyl amine, |
| Part II | |
| 29 | 10% water solution of polyvinyl alcohol sold under |
| | the trade name of Cevol 540 by Celanese, |
| | Dallas, USA |
| 0.7 | Wetting agent, sold under the trade name of Q2 |
| | 5211 by Dow Corning, Midland, USA |
| 0.5 | Amorphous silicone dioxide agent, sold under |
| | the trade name of Syloid C809 by Grace Davidson, |
| | Worms, Germany |
| 20 | Isopropanol |
| b.t.w | Water |

The components of Part I of the Table 3 presented above are mixed and left to react for a reaction period of about 72 hours. At the end of the reaction period, the components of Part II are added to the solution.

(b) The active hydrophilic coating is coated onto a SH-81 clear 125 micron PET film sold by SKC, Covington, USA using a wire-wound rod #29 sold by Buschman Corp. Cleveland, USA. The coated film is then dried at 70° C.

### EXAMPLE 4

(a) preparing the active hydrophilic coating

TABLE 4

| Weight % | Ingredients of active hydrophilic coating |
|---|---|
| 73 | Methylethylketone |
| 18 | Isopropanol |
| 9 | Polyvinylpyrrolidone, sold under the trade name |
| | LUVITEC K 90 by BASF Ludwigshafen, Germany |

The components of Table 4 presented above are mixed and applied onto a SH81 clear 125 micron PET film sold by SKC, Covington, USA using a rod #3 sold by RK Print Coat Instrument, Litington, UK. The coated film is then dried at 70° C.

Referring back to FIG. 9, as indicated at box 920, the method may include imaging an image on the coated transfer media by selectively applying an image carry material to the surface forming coating of the transfer media. FIG. 10A is a cross sectional illustration of an imaged transfer media 120. The imaged transfer media may include a blank transfer media 122 coated with an active hydrophilic layer 124 having on its surface two areas 126 and 128 on which the image carry material was selectively applied according to a pre-defined pattern.

The imaging operation may be performed inline on a plate-making system having an imaging unit or at a separate imaging system. The imaging operation may be preformed in various imaging technologies such as for example, laser printing, electophotography printing, inkjet printing, wax thermal transfer, ionography and others. Various image carry materials may be used, such as laser printer toner, inkjet ink and others.

As indicated at box 940, the method may include applying the coating material onto a substrate 130 or imaged coated transfer media 120. Imaged coated transfer media 120 may then be laminated onto substrate 130 such that the coating material is trapped between substrate 130 and imaged coated transfer media 120. This lamination process may be done by any suitable lamination process known in the art, such as wet lamination, ironing lamination described in WO 04/014651 and others.

As indicated at box 960, the method may include conditioning the coating material to form a solid imaging layer. The conditioning may include radiation curing, such as ultraviolet curing, thermal curing, drying and fusing using one or more conditioning units. FIG. 10B illustrates the outcome of the lamination and curing processes.

As illustrated, coating material 132 is captured between imaged coated transfer media 120 and substrate 130. According to embodiments of the present invention, during the lamination process, the image carry material may be dipped into coating material 132 to form imaged areas 134. Alternatively, according to other embodiments of the present invention, the image carry material may cover the surface of coating material 132 and may function as a mask between coating material 132 and surface forming coating 124.

Following the conditioning process, the printing member may include non-imaged areas, designated 136, which are the interface areas between coating material 132 and surface forming coating 124. FIG. 10C is an enlarged view of circle E1 of FIG. 10B illustrating the interface surroundings. Imaged areas 134 and non-imaged areas 136 have different affinity to ink and/or ink-repellent fluid. According to some embodiments of the present invention, non-imaged areas 136 have hydrophilic properties and the imaged areas 134 have hydrophobic properties. It should be understood by a person of ordinary skill in the art that such a printing member may be used in wet offset printing.

Although, embodiments of the present invention are not limited in this respect, it is believed that upon curing, the surface properties of coating material 132 may be modified by reacting with active hydrophilic coating 124 at the non-imaged areas 136 which are not covered with the image carry material. Accordingly, according to exemplary embodiments of the present invention, the non-imaged areas 136 changes from being hydrophobic to being hydrophilic upon the interaction with the surface forming coating.

Following are exemplary composition of coating material useful for preparing printing members for wet offset printing according to embodiments of the present invention. It should be understood to a person of ordinary skill in the art that there may be many variations to compositions of the coating material, and the compositions which are given, by way of illustration only, do not limit the scope of the present invention in that respect. In the following examples, component designations are in weight percentages.

### EXAMPLE 5

TABLE 5

| Weight % | Ingredients of coating material |
|---|---|
| 76 | Urethane acrylate olygomer, sold under the trade name |
| | of Ebecryl 4858 by Cytec Surface Specalists, |
| | Drogenbos, Belgium |
| 20 | acrylate monomer, sold under the trade name of |
| | Photomer 4158 by Cognis, Cincinnati, USA |
| 2 | Photoinitiator, sold under the trade name of Darocure |
| | 4265 by Ciba Speciality Chemicals, Basel, Switzerland |
| 2 | An acrilated adhesion promoter sold under the trade |
| | name of Sartomer 9051 by Cray Valley, Exton, USA |

The composition of Example 5 described in Table 5 above may be used to coat substrate 130. A non-limiting example of suitable substrate may be an anodized aluminum sheet. The coated anodized aluminum may be laminated with an imaged transparent transfer film coated with the active hydrophilic coating of Example 1 as described in Table 1. The image on the transparent transfer film may be formed using a toner sold under the trade name C4129X toner by Hewlett Packard for use with HP LaserJet laser printer (series 5000-5100). After lamination, the coating material of Example 5 may be conditioned using ultraviolet radiation.

Although, embodiments of the present invention are not limited in this respect, it is believed that upon curing, the acrylic groups of the composition depicted in Example 5 interacts with the acrylate substituted copolymer of the active hydrophilic coating to create surface with hydrophilic properties at the non-imaged areas 136.

### EXAMPLE 6

TABLE 6

| Weight % | Ingredients of coating material |
|---|---|
| 62.3 | Urethane acrylate olygomer, sold under the trade name |
| | of Ebecryl 4858 by Cytec Surface Specalists, |
| | Drogenbos, Belgium |
| 19.9 | acrylate monomer, sold under the trade name of |
| | Photomer 4158 by Cognis Cincinnati, USA |
| 13.3 | Tripropylen glycol diacrylate monomer, sold under the |
| | trade name of SR 306 by Cray Valley, Exton, USA |
| 2 | Acrylated adhesion promoter, sold under the trade |
| | name of Sartomer 9051 by Cray Valley, Exton, USA |
| 0.5 | photoinitiator, sold under the trade name of Irgacure |
| | 819 by Ciba Speciality Chemicals, Basel, Switzerland |
| 2 | photoinitiator, sold under the trade name of Darocure |
| | 4265 by Ciba Speciality Chemicals, Basel, Switzerland |

The composition of Example 6 described in Table 6 above may be used to coat substrate 130. A non-limiting example of suitable substrate may be a grade aluminum sheet. The coated aluminum may be laminated with an imaged transparent transfer film coated with the active hydrophilic coating of Example 2 as described in Table 2. The image on the transparent transfer film may be formed using a toner sold under the trade name C4129X toner by Hewlett Packard for use with HP LaserJet laser printer (series 5000-5100). After lamination, the coating material of Example 6 may be conditioned using ultraviolet radiation.

Although, embodiments of the present invention are not limited in this respect, it is believed that upon curing, the acrylic groups of the composition depicted in Example 6 interacts with the acrylate substituted polyacrylic acid of the active hydrophilic coating to create surface with hydrophilic properties at the non-imaged areas 136.

### EXAMPLE 7

TABLE 7

| Weight % | Ingredients of coating material |
|---|---|
| 69 | Urethane acrylate olygomer, sold under the trade name |
| | of Ebecryl 4858 by Cytec Surface Specalists, |
| | Drogenbos, Belgium |
| 6.6 | silicone acrylate monomer, sold under the trade name |
| | of Ebecryl 1360 by Cytec Surface Specalists, |
| | Drogenbos, Belgium |
| 19.9 | Tripropylen glycol diacrylate monomer, sold under |
| | the trade name of SR 306 by Cray Valley, Exton, USA |
| 2 | Acrylated adhesion promoter, sold under the trade |
| | name of Sartomer 9051 by Cray Valley, Exton, USA |
| 0.5 | photoinitiator, sold under the trade name of Irgacure |
| | 819 by Ciba Speciality Chemicals, Basel, Switzerland |
| 2 | photoinitiator, sold under the trade name of Darocure |
| | 4265 by Ciba Speciality Chemicals, Basel, Switzerland |

The composition of Example 7 described in Table 7 above may be used to coat substrate 130. A non-limiting example of suitable substrate may be a PET sheet. The coated PET sheet may be laminated with an imaged transparent transfer film coated with the active hydrophilic coating of Example 3 as described in Table 3. The image on the transparent transfer film may be formed using an inkjet sold under the trade name T5652 UltraChrome k3 ink by Epson for use with Epson Stylus Pro inkjet printers. After lamination, the coating material of Example 7 may be conditioned using ultraviolet radiation.

Although, embodiments of the present invention are not limited in this respect, it is believed that upon curing, the acrylic groups of the composition depicted in Example 7 interacts with the acrylate substituted polyacrylic acid of the active hydrophilic coating to create surface with hydrophilic properties at the non-imaged areas 136.

### EXAMPLE 8

TABLE 8

| Weight % | Ingredients of coating material |
|---|---|
| 48.9 | Urethane acrylate olygomer, sold under the trade name |
| | of Sartomer CN975 by Cray Valley, Exton, USA |
| 11.5 | Multifunctional acrylate monomer, sold under the trade |
| | name of Genomer 1456 by Rahn, Zurich, Switzerland |
| 9.3 | Tripropylen glycol diacrylate monomer, sold under the |
| | trade name of SR 306 by Cray Valley, Exton, USA |
| 12.1 | Acrylated adhesion promoter, sold under the trade name |
| | of Sartomer 9051 by Cray Valley, Exton, USA |
| 16.5 | acrylate monomer, sold under the trade name of Photomer |
| | 4158 by Cognis, Cincinnati, USA |
| 1.6 | photoinitiator, sold under the trade name of Darocure |
| | 4265 by Ciba Speciality Chemicals, Basel, Switzerland |

The composition of Example 8 described in Table 8 above may be used to coat substrate 130. A non-limiting example of suitable substrate may be a PET sheet. The coated PET sheet may be laminated with an imaged transparent transfer film coated with the active hydrophilic coating of Example 4 as described in Table 4. The image on the transparent transfer film may comprise, for example, C4129X toner for HP LaserJet laser printer series 5000-5100. After lamination, the coating material of Example 8 may be conditioned using ultraviolet radiation.

Although, embodiments of the present invention are not limited in this respect, it is believed that the carboxylic groups of the ultraviolet-cured coating of Example 8 provide strong interaction with the PVP layer of the active hydrophilic coating to create a surface with hydrophilic properties at the non-imaged areas 136.

As indicated at box 980 and illustrated in FIG. 10D, the method may include removing transfer media 120 to expose the desired image on the surface of the imaging layer. If the transfer media is a film, it may be kept as a protective film to be removed prior to printing It should be understood, that the image on the imaging layer is the mirror-image of the pattern formed by the image carry material on the transfer media. As illustrated in FIG. 10D, active hydrophilic material 124 may be delaminated from transfer media 120 to remain onto the cured imaging layer. As indicated at box 990, in such cases, the imaged printing member may be further cleaned. The active hydrophilic material may be removed from the imaged areas by washing the printing member using water or fountain solution prior to printing. According to other embodiments of the present invention, active hydrophilic layer 124 may be removed together with the removal of transfer media 122.

The imaged surface of the imaging layer produced by the process described above includes non-imaged areas 136 termed interface areas and imaged areas 134 made of the image carry material. It should be understood to a person skilled in the art of printing, that the non-imaged areas and the imaged areas have different affinity to ink and/or ink-repellent fluid.

While certain features of the invention have been illustrated and described herein, many modifications, substitutions, changes, and equivalents will now occur to those of ordinary skill in the art. It is appreciated that various modifications may occur to those skilled in the art that, while not specifically shown herein, are nevertheless within the true spirit and scope of the invention.

What is claimed is:

1. A method for manufacturing an imaged printing member, the method comprising:
transferring an image onto a printing member during manufacturing by transferring an image carry material from an imaged transfer media onto a coating material, the coating material being captured in between a substrate of the printing member and the imaged transfer media; and
conditioning the coating material to form said imaged printing member.

2. The method of claim 1 wherein the printing member is a lithographic printing member.

3. The method of claim 1, wherein conditioning comprises radiating with ultraviolet radiation.

4. The method of claim 2, wherein the image transfer media is coated with a surface forming coating.

5. The method of claim 1, wherein the image transfer media is a belt.

6. The method of claim 4, wherein conditioning the coating material comprises forming an interface area between the coating material and the surface forming coating in non-imaged areas of said imaged printing member.

7. The method of claim 6, wherein the interface area and the image carry material have different affinity to ink-repellent fluid.

8. The method of claim 6, wherein the interface area and the coating material have different affinity to ink-repellent fluid.

9. The method of claim 7, wherein the ink-repellent fluid is water-based.

10. The method of claim 1, wherein the image carry material is a toner.

11. The method of claim 1, wherein the image carry material is an inkjet ink.

12. The method of claim 6 further comprising:
removing the transfer member from the imaged printing member.

13. The method of claim 12 further comprising:
cleaning the imaged printing member.

14. The method of claim 4, wherein the surface forming coating is an active hydrophilic coating.

15. The method of claim 14, wherein the active hydrophilic coating comprises one or more hydrophilic polymers selected from the group consisting of poly(vinyl alcohol), poly(vinyl pyrrolidone), poly-oxazolines, poly(acrylamide), poly(acrylic acid), poly(methacrylic acid), copolymers of maleic anhydride and maleic acid, and poly(vinyl phosphonic acid) with their copolymers.

16. The method of claim 4, wherein the active hydrophilic coating comprises one or more hydrophilic polymers substituted with an acrylic, acrylamido or methacrylic group.

17. The method of claim 1, wherein the coating material comprises one or more ultraviolet curable acrylates selected from the group consisting of urethane acrylate oligomeres, epoxy acrylate oligomers, acrylate monomers and methacrylate monomers.

18. An imaged printing member for transmitting ink in a printing machine, the printing member comprising:
a solid substrate; and
an imaging layer over the substrate, said imaged printing member is produced by:
imaging a selected image onto a transfer media by applying an image carry material onto said transfer media;
applying a coating material onto said substrate and/or the imaged transfer film;
laminating the imaged transfer film with the substrate such that the coating material is captured in between; and
conditioning the coating material to form said imaging layer, said imaging layer having imaged areas comprising the image carry material and non-imaged areas.

19. The imaged printing member of claim 18, wherein the printing member is a lithographic printing member.

20. The imaged printing member of claim 18, wherein the transfer film is coated with surface forming coating and wherein a top layer of said non-imaged areas is an interface area between the coating material and the surface forming coating.

21. The imaged printing member of claim 20, wherein the imaged areas and the non-imaged areas have different affinities for ink and/or ink-repellent fluid.

22. The imaged printing member of claim 20, wherein the imaged areas are oleophilic and the non-imaged areas are hydrophilic.

23. The imaged printing member of claim 20, wherein said interface area is a hydrophilic interface area.

24. An apparatus for manufacturing an imaged printing member, the apparatus comprising:
a substrate handling mechanism to support and conduct a substrate;
a first applicator to apply a surface forming coating onto a blank transfer media;
an imaging unit to image the coated transfer media using an image carry material;
a second applicator to apply a coating material onto the substrate and/or the imaged transfer media; and
a lamination handling unit to laminate the imaged transfer media with the substrate, said lamination handling unit configured such that during lamination of the imaged transfer media with the substrate the coating material is captured in between the imaged image media and the substrate.

25. The apparatus of claim 24 further comprising:
a curing unit to cure the coating material to form an imaged printing member.

26. The apparatus of claim 24, wherein the transfer media is a belt.

27. The apparatus of claim 26 further comprising:
a separator to separate the belt from the imaged printing member.
